(19) United States
(12) Patent Application Publication
(10) Pub. No.: US 2015/0368945 A1
(43) Pub. Date: Dec. 24, 2015

(54) DOOR HINGE FOR AUTOMOBILE AND METHOD FOR MANUFACTURING FIRST BRACKET THEREOF

(71) Applicant: RIKENKAKI KOGYO KABUSHIKI KAISHA, Sakado-shi, Saitama (JP)

(72) Inventors: Seiji SASA, SAKADO-SHI, SAITAMA (JP); Manabu OCHIAI, SAKADO-SHI, SAITAMA (JP)

(21) Appl. No.: 14/765,720

(22) PCT Filed: Feb. 4, 2014
(86) PCT No.: PCT/JP2014/052547

§ 371 Date: Aug. 4, 2015

(30) Foreign Application Priority Data
Feb. 5, 2013 (JP) 2013-020819

(51) Int. Cl. E05D 5/06; E05D 3/02; E05D 11/06

(52) U.S. Cl. CPC E05D 5/062; E05D 11/06; E05D 3/02

(57) ABSTRACT

A door hinge for an automobile includes a first bracket fixed to a body, a second bracket fixed to a door, and a hinge pin, the first bracket including a base plate portion having a bolt hole, a pair of arm plate portions standing up from upper and lower edges of one end part, on the door side, of the base plate portion and supporting the hinge pin, and a pair of rib portions extending from the arm plate portion and standing up from the upper and lower edges of the base plate portion so as to oppose each other with the bolt hole interposed therebetween, wherein opposite end parts, perpendicular to the extending direction of the rib portion, of the base plate portion are open, and the rib portion is formed so as to have a thickness larger than a thickness of the arm plate portion.

### TECHNICAL FIELD

The present invention relates to a door hinge for an automobile that links a door for opening and closing an entrance or a tailgate of the automobile to a body, and a method for manufacturing a first bracket of the door hinge that is fixed to the body.

### BACKGROUND ART

A conventional door hinge for an automobile is formed from a first bracket fixed to a body by means of a bolt, a second bracket fixed to a door, and a hinge pin relatively pivotably linking these two brackets, the first bracket being formed from a base plate portion having a bolt hole through which the bolt is inserted, a pair of arm plate portions standing up from upper and lower edges of one end part, on the door side, of the base plate portion and supporting the hinge pin, and a pair of rib portions extending from the arm plate portion toward the other end part side of the base plate portion and standing up from upper and lower edges of the base plate portion so as to oppose each other with the bolt hole interposed therebetween.

In such a door hinge for an automobile, since the first bracket for the body supports the entire weight of the door when the door is open, the base plate portion in particular, which is joined to the body by means of a bolt, is required to have high stiffness, and in order to satisfy this requirement, in the conventional arrangement a reinforcing wall linking the pair of arm plate portions is made to stand up from an end part, on the arm plate portion side, of the base plate portion (refer to Patent Document 1).

### RELATED ART DOCUMENTS

### Patent Documents

### Patent Document 1: Japanese Patent Application Laid-open No. 2009-24429

### SUMMARY OF THE INVENTION

### Problems to be Solved by the Invention

As described above, when the reinforcing wall linking the pair of arm plate portions is made to stand up from an end part, on the arm plate portion side, of the base plate portion, since the pair of arm plate portions and the reinforcing wall are made to stand up from three sides of the base plate portion, production of the first bracket requires a drawing process, which has a relatively high processing cost. Therefore, it is difficult to reduce the processing cost for the structure of the first bracket of the conventional door hinge.

The present invention has been accomplished in light of such circumstances, and it is an object thereof to provide a door hinge for an automobile equipped with a first bracket that is easy to process and can ensure high stiffness, and to provide a method for manufacturing the first bracket thereof.

### Means for Solving the Problems

In order to attain the above object, according to a first aspect of the present invention, there is provided a door hinge for an automobile, comprising a first bracket fixed to a body by a bolt, a second bracket fixed to a door, and a hinge pin relatively pivotably linking these two brackets, the first bracket comprising a base plate portion having a bolt hole through which the bolt is inserted, a pair of arm plate portions standing up from upper and lower edges of one end part, on the door side, of the base plate portion and supporting the hinge pin, and a pair of rib portions extending from the arm plate portion toward the other end part side of the base plate portion and standing up from the upper and lower edges of the base plate portion so as to oppose each other with the bolt hole interposed therebetween, characterized in that opposite end parts, perpendicular to the extending direction of the rib portion, of the base plate portion are open, and the rib portion is formed so as to have a thickness that is larger than a thickness of the arm plate portion.

Further, according to a second aspect of the present invention, in addition to the first aspect, the rib portion is formed so that an outside face thereof protrudes more than an outside face of the arm plate portion.

Furthermore, according to a third aspect of the present invention, in addition to the first aspect, a corner formed by an outside face of the rib portion and an outside face of the base plate portion is formed so as to be acute compared with a corner formed by the outside face of the arm plate portion and the outside face of the base plate portion.

Moreover, according to a fourth aspect of the present invention, in addition to any one of the first to third aspects, in order to restrict a fully open position of the door a fully-open stopper projection having a semi-circular cross section with a flat stopper face that receives the arm plate portion of the second bracket is formed so as to bulge on an inside face of the arm plate portion of the first bracket.

Further, according to a fifth aspect of the present invention, there is provided a method for manufacturing the first bracket of the door hinge for an automobile, comprising a step of stamping out a starting steel plate to form a flat-plate bracket substrate having portions corresponding to the base plate portion, the arm plate portion, and the rib portion, a step of bending the arm plate portion and the rib portion at right angles relative to the base plate portion of the bracket substrate to thus obtain a partially-finished bracket product, and a step of thickening the rib portion of the partially-finished bracket product by an upsetting process, the steps being carried out in sequence.

### Effects of the Invention

In accordance with the first aspect of the present invention, since the opposite end parts, perpendicular to the extending direction of the rib portion, of the base plate portion are made open, and the rib portion is formed so that the thickness thereof is larger than the thickness of the arm plate portion, it is possible to increase effectively the stiffness of the rib portion, make the stress be sufficiently borne by the rib portion, and relieve the stress from the area around the bolt hole of the base plate portion, thus increasing the stiffness of the base plate portion and enabling the door to be strongly supported, and it is also possible to reduce the thickness of the entire first bracket, thereby achieving a reduction in the weight of the first bracket. Moreover, since the base plate portion is formed into a flat plate shape with the opposite end parts open, it becomes possible to form the arm plate portion and the rib portion by simple bending, and it is also possible to easily increase the thickness by subjecting the rib portion to simple upsetting, thereby contributing to a reduction of the processing cost.

In accordance with the second aspect of the present invention, since the rib portion is formed so that the outside face thereof protrudes further from the outside face of the arm plate portion, the width of the base plate portion increases by a portion corresponding to the increase in thickness of the rib portion, thus further increasing the stiffness of the base plate portion, and the area of the base plate portion that is joined to the body increases, thus enhancing the stability with which the base plate portion is supported on the body.

In accordance with the third aspect of the present invention, since the corner formed from the outside face of the rib portion and the outside face of the base plate portion is formed so as to be acute compared with the corner formed from the outside face of the arm plate portion and the outside face of the base plate portion, not only is it possible to enhance the stiffness of the rib portion, but it is also possible to increase the area of the base plate portion that is joined to the body, thereby yet further enhancing the stability with which the base plate portion is supported on the body.

In accordance with the fourth aspect of the present invention, since, in order to restrict the fully open position of the door, the fully-open stopper projection having a semi-circular cross section with the flat stopper face that receives the arm plate portion of the second bracket is formed so as to bulge on an inside face of the arm plate portion of the first bracket, when the door is open the arm plate portion of the second bracket abuts against the flat stopper face of the fully-open stopper projection, thus enabling the fully open position of the door to be restricted. In this arrangement, since the flat stopper face is in flat surface contact with the arm plate portion of the second bracket, the contact surface pressure is held comparatively low and, moreover, since the stopper projection has a semicircular cross-sectional shape, which has high stiffness, the durability can be maintained. Furthermore, since the stopper projection is formed so as to bulge on the inside face of the arm plate portion, there is no increase in the number of components, thus contributing to simplification of the structure.

In accordance with the fifth aspect of the present invention, due to the step of stamping out a starting steel plate to form a flat-plate bracket substrate having portions corresponding to the base plate portion, the arm plate portion, and the rib portion, the step of bending the arm plate portion and the rib portion at right angles relative to the base plate portion of the bracket substrate to thus obtain a partially-finished bracket product, and the step of thickening the rib portion of the partially-finished bracket product by an upsetting process being carried out in sequence, it is possible to easily obtain a first bracket having a base plate portion with open opposite end parts and having a thickened rib portion, thus enabling the processing cost to be reduced while enhancing the stiffness of the first bracket.

### BRIEF DESCRIPTION OF DRAWINGS

FIG. 1 is a plan view of an essential part of an automobile equipped with a door hinge related to an embodiment of the present invention. (first embodiment)

FIG. 2 is a perspective view of the door hinge. (first embodiment)

FIG. 3 is an exploded perspective view of the same door hinge. (first embodiment)

FIG. 4 is an enlarged sectional view along line 4-4 in FIG. 3. (first embodiment)

FIG. 5 is a sectional view along line 5-5 in FIG. 1. (first embodiment)

FIG. 6 is a diagram of production steps for a first bracket in the door hinge. (first embodiment)

### EXPLANATION OF REFERENCE NUMERALS AND SYMBOLS

B Body
D Door
H Door hinge
T1 Thickness of arm plate portion of first bracket
T2 Thickness of rib portion of first bracket
1 First bracket
1a Base plate portion of first bracket
1b Arm plate portion of first bracket
1c Rib portion of first bracket
2 Second bracket
2a Base plate portion of second bracket
2b Arm plate portion of second bracket
3 Bolt
5 Hinge pin
8 Bolt hole
9 Corner on arm plate portion side of first bracket
10 Corner on rib portion side of first bracket
12 Fully-open stopper projection
12a Stopper face
20 Starting steel plate
21 Bracket substrate
22 Partially-finished bracket product

### MODES FOR CARRYING OUT THE INVENTION

An embodiment of the present invention is explained below by reference to the attached drawings.

### First Embodiment

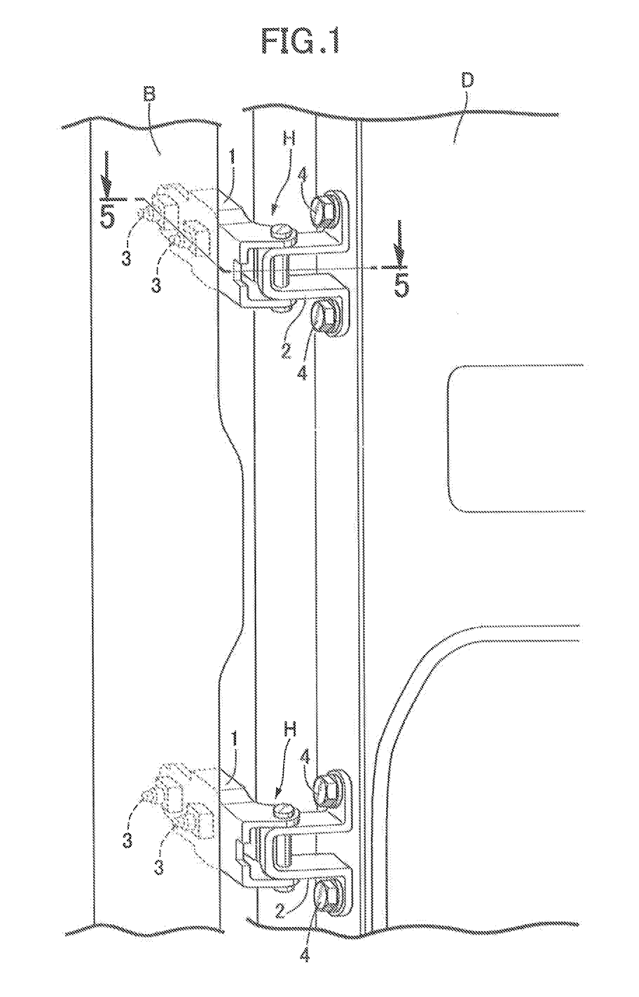

First, in FIG. 1, a door D is pivotably mounted on a body B of an automobile via a pair of upper and lower door hinges H in order to open and close its entrance.

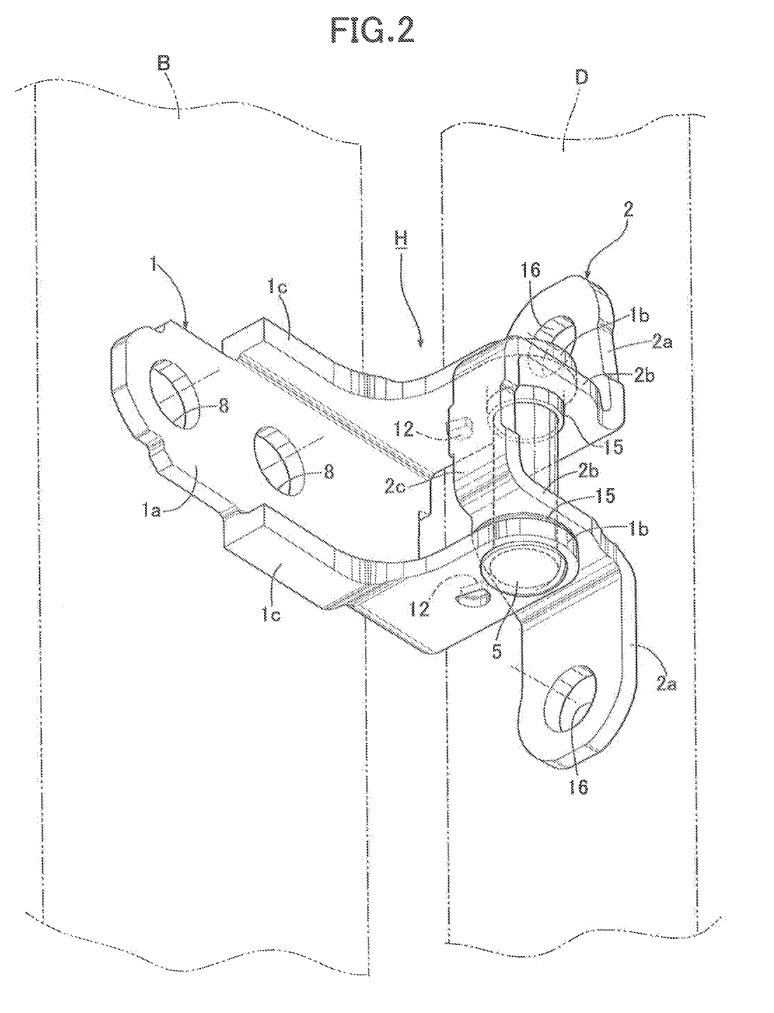

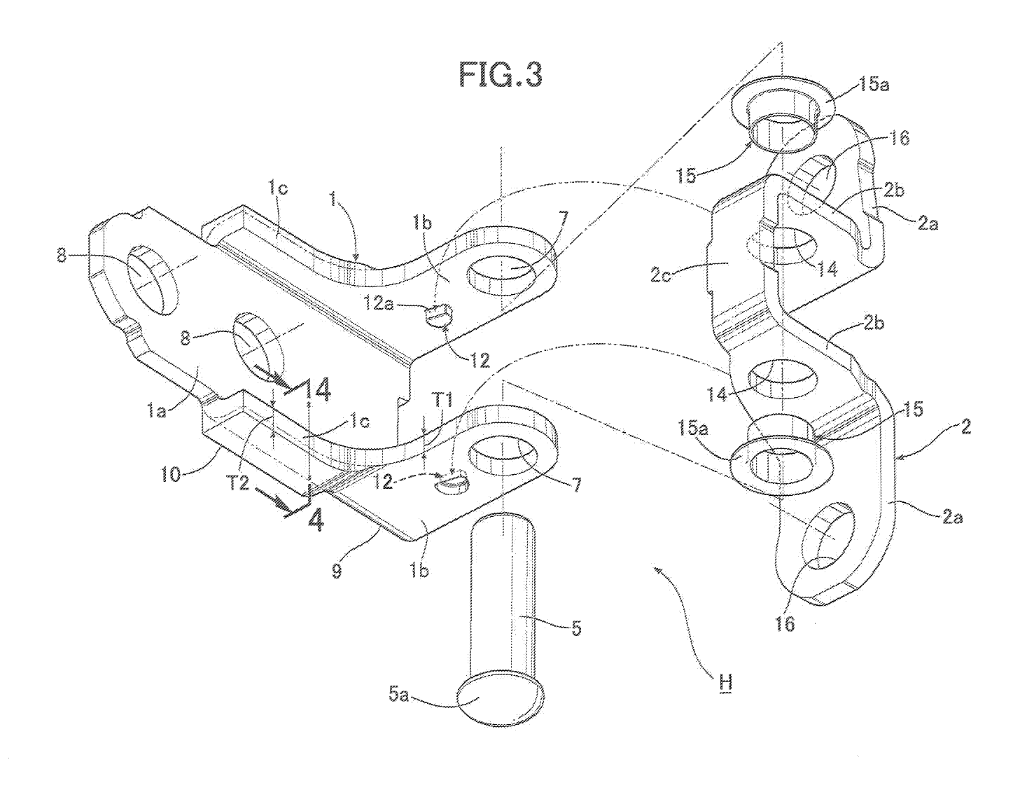

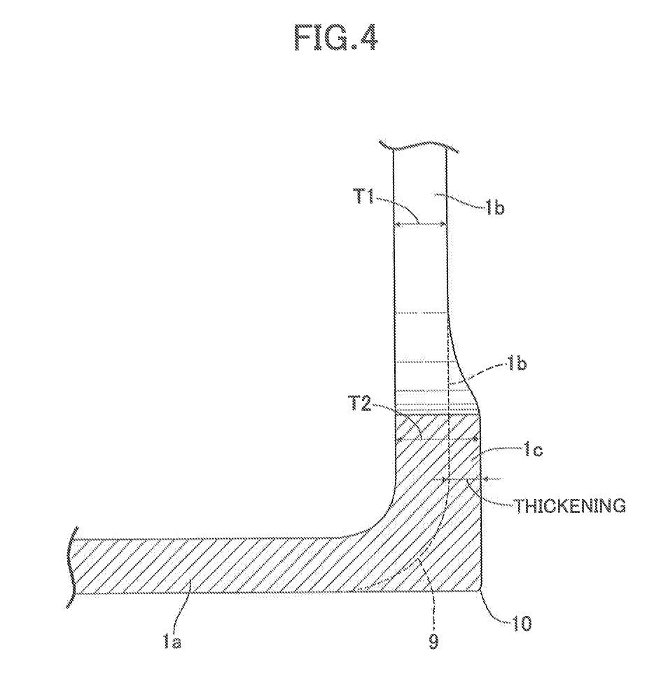

As shown in FIG. 2 to FIG. 4, each door hinge H is formed from a first bracket 1 fixed to the body B by means of a pair of bolts 3, a second bracket 2 fixed to the door D by means of a pair of bolts 4, and a hinge pin 5 vertically disposed so as to relatively pivotably link these two brackets 1 and 2.

The first bracket 1 is formed from a base plate portion 1a, a pair of arm plate portions 1b and 1b standing up from upper and lower edges of one end part, on the door D side, of the base plate portion 1a, and a pair of rib portions 1c and 1c standing up from the upper and lower edges of the base plate portion 1a so as to extend from the arm plate portions 1b and 1b toward the other end part side of the base plate portion 1a, the base plate portion 1a having opposite end parts perpendicular to the extending direction of the rib portions 1c and 1c open. Bored in the base plate portion 1a are a pair of bolt holes 8 and 8 through which the pair of bolts 3 and 3 are inserted, and bored in the arm plate portions 1b and 1b are pin holes 7 and 7 through which the hinge pin 5 is inserted.

Each rib portion 1c is formed so that a thickness T2 thereof is larger than a thickness T1 of the arm plate portion 1b, and an outside face of the rib portion 1c protrudes further than an outside face of the arm plate portion 1b. Furthermore, a corner 10 formed from the outside face of the rib portion 1c and an outside face of the base plate portion 1a is formed so as to be acute compared with a corner 9 formed from the outside face of the arm plate portion 1b and the outside face of the base plate portion 1a.

Integrally and projectingly provided on the inside face of the arm plate portion 1b is a fully-open stopper projection 12 for receiving an arm plate portion 2b, which is described later, of the second bracket 2 in order to restrict the fully open position of the door D. This fully-open stopper projection 12 is formed so as to bulge on the inside face of the arm plate portion 1b by pressing out the arm plate portion 1b from the outside face side, and has a semicircular cross-sectional shape having a flat stopper face 12a on one side.

On the other hand, the second bracket 2 is formed from the pair of upper and lower arm plate portions 2b and 2b, a linking plate portion 2c integrally linking extremities of the two arm plate portions 2b and 2b, and a pair of base plate portion 2a and 2a protruding while bending from the base end of the respective arm plate portion 2b toward the outside. Bored in the base plate portions 2a and 2a are bolt holes 16 and 16 through which the bolts 4 and 4 are inserted.

A washer 15a-equipped bush 15 is fitted in each of pin holes 14 and 14 of the arm plate portions 2b and 2b. The arm plate portions 2b and 2b are inserted between the arm plate portions 1b and 1b of the first bracket 1, and in this process the washer 15a of the bush 15 is disposed between the first and arm plate portions 1b and 2b.

The hinge pin 5, which is equipped with an expanded head portion 5a, is inserted through the pin holes 7 and 7 of the arm plate portions 1b and 1b and the bushes 15 and 15 of the arm plate portions 2b and 2b, and the extremity of the hinge pin 5 is swaged. In this way, the first and second brackets 1 and 2 are relatively pivotably linked via the hinge pin 5, thus forming the door hinge H.

The operation of this embodiment is now explained.

The door hinge H is mounted on the body B by securing the base plate portion 1a of the first bracket 1 to the body B by means of the bolts 3 and 3 inserted through the bolt holes 8 and 8, and the door D is supported on the first bracket 1 via the second bracket 2 and the hinge pin 5 so that it can freely open and close by securing the door D to the base plate portions 2a and 2a of the second bracket 2 by means of the bolts 4 and 4 inserted through the bolt holes 16 and 16 of the base plate portions 2a and 2a.

Therefore, when the door D is open, the entire weight thereof is imposed on the first bracket 1, and the weight burden on the base plate portion 1a, which is secured by means of the bolts 3 and 3, is large. In particular, it has been found from stress analysis that, due to the base plate portion 1a being formed into a flat plate shape with opposite end parts thereof open, stress is concentrated not only in the rib portion 1c but also in an area around the bolt holes 8 and 8 of the base plate portion 1a.

In the present invention, as described above, since the rib portion 1c is formed so that the thickness T2 thereof is larger than the thickness T1 of the arm plate portion 1b, it is possible to increase effectively the stiffness of the rib portion 1c, make the stress be sufficiently borne by the rib portion 1c, and relieve the stress from the area around the bolt holes 8 and 8 of the base plate portion 1a, thus increasing the stiffness of the base plate portion 1a and enabling the door D to be strongly supported, and it is also possible to reduce the thickness of the entire first bracket 1, thereby achieving a reduction in the weight of the first bracket 1.

Moreover, in the first bracket 1, since the base plate portion 1a is formed into a flat plate shape with the opposite end parts open, it becomes possible to form the arm plate portions 1b and 1b and the rib portions 1c and 1c by simple bending, and it is also possible to easily increase the thickness by subjecting the rib portion 1c to simple upsetting, thereby contributing to a reduction of the processing cost.

Furthermore, when forming the rib portion 1c so as to have large thickness, since the rib portion 1c is formed so that the outside face thereof protrudes further from the outside face of the arm plate portion 1b, the width of the base plate portion 1a increases by a portion corresponding to the increase in thickness of the rib portions 1c and 1c, thus further increasing the stiffness of the base plate portion 1a, and the area of the base plate portion 1a that is joined to the body B increases, thus enhancing the stability with which the base plate portion 1a is supported on the body B.

Moreover, since the corner 10 formed from the outside face of the rib portion 1c and the outside face of the base plate portion 1a is formed so as to be acute compared with the corner 9 formed from the outside face of the arm plate portion 1b and the outside face of the base plate portion 1a, not only is it possible to enhance the stiffness of the rib portion 1c, but it is also possible to increase the area of the base plate portion 1a that is joined to the body B, thereby yet further enhancing the stability with which the base plate portion 1a is supported on the body B.

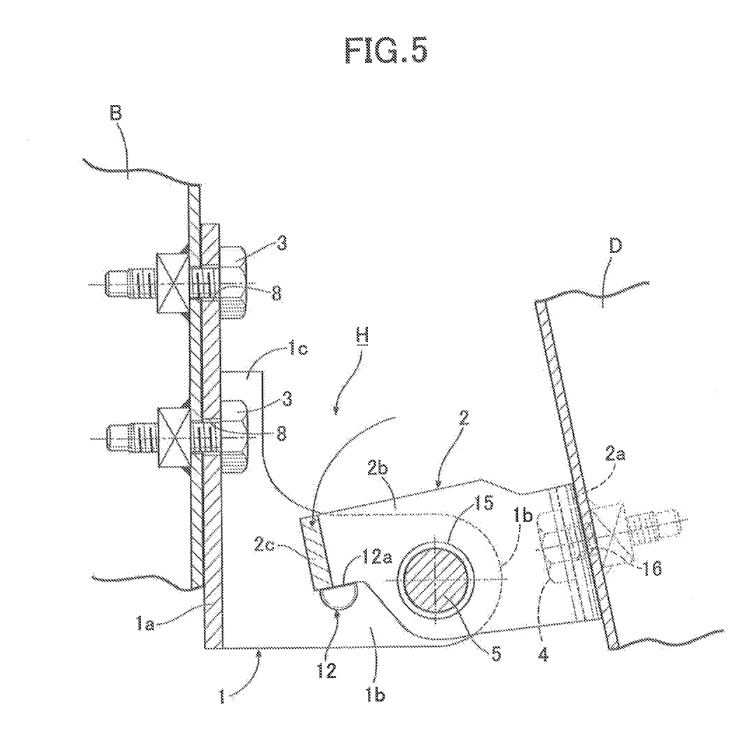

When the door D is being opened, as shown in FIG. 5, the fully open position of the door D is restricted due to the arm plate portion 2b of the second bracket 2 abutting against the flat stopper face 12a of the fully-open stopper projection 12 of the arm plate portion 1b of the first bracket 1. In this arrangement, since the flat stopper face 12a is in flat surface contact with the arm plate portion 2b, the contact surface pressure is held comparatively low and, moreover, since the stopper projection 12 has a semicircular cross-sectional shape, which has high stiffness, the durability can be maintained. Furthermore, since the stopper projection 12 is formed so as to bulge on the inside face of the arm plate portion 1b, there is no increase in the number of components, thus contributing to simplification of the structure.

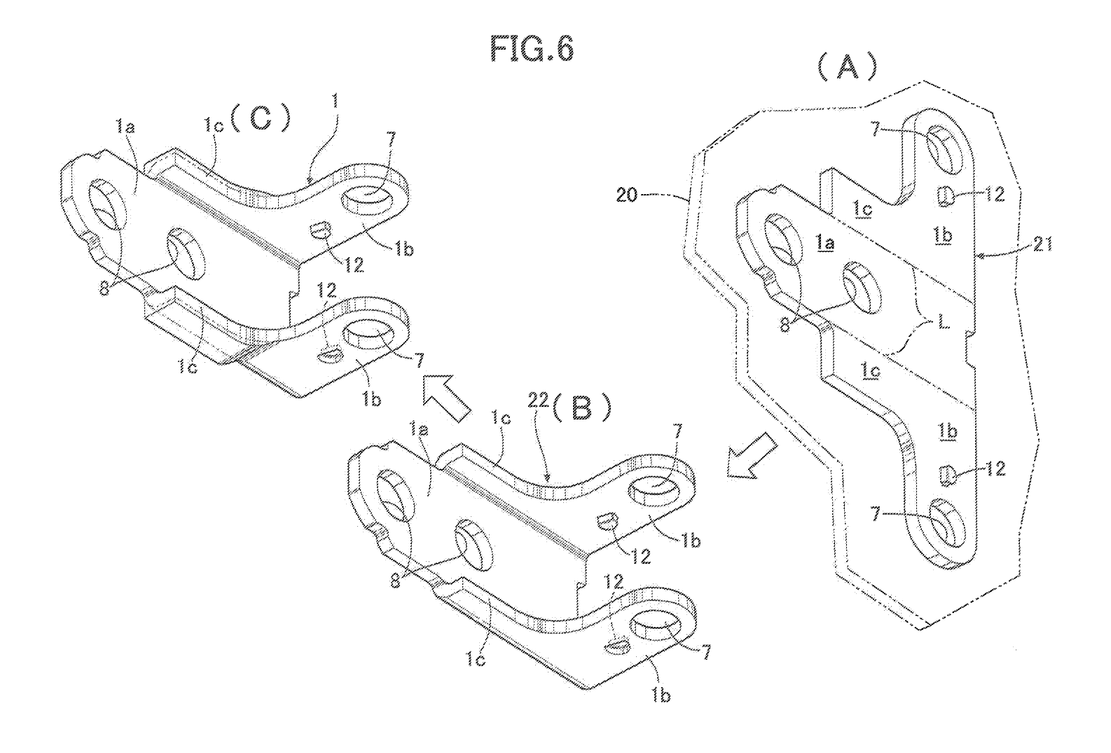

A method for manufacturing the first bracket 1 is now explained by reference to FIG. 6.

First, as shown in FIG. 6 (A), a starting steel plate 20 is stamped using a press machine to form a flat plate bracket substrate 21 having portions corresponding to the base plate portion 1a, the arm plate portions 1b and 1b, and the rib portions 1c and 1c. In this process, the bolt holes 8 and 8 are bored in the base plate portion 1a, the pin holes 7 and 7 are bored in the arm plate portions 1b and 1b, and the stopper projections 12 and 12 are formed so as to bulge on the arm plate portions 1b and 1b.

Subsequently, as shown in FIG. 6 (B), the base plate portion 1a of the bracket substrate 21 and the arm plate portions 1b and 1b and rib portions 1c and 1c are bent through right angles along boundary lines L and L using the press machine, thus giving a partially-finished bracket product 22.

Finally, as shown in FIG. 6 (C), the rib portions 1c and 1c are subjected to upsetting in the height direction thereof, thus making the rib portions 1c and 1c thicker than the base plate portion 1 a and the arm plate portions 1b and 1b. The first bracket 1 is thus obtained.

In this way, the first bracket 1, which has the base plate portion 1a with opposite end parts open and the rib portions 1c and 1c having increased thickness, can be easily obtained by carrying out simple bending and upsetting, thus enabling a reduction in the processing cost to be achieved while enhancing the stiffness.

The present invention is not limited to the embodiment and may be modified in a variety of ways as long as the modifications do not depart from the spirit and scope thereof. For example, the present invention may be applied to a hinge for a tailgate door, a boot lid, an engine hood, etc. of an automobile.

1. A door hinge for an automobile, comprising a first bracket fixed to a body by a bolt, a second bracket fixed to a door, and a hinge pin relatively pivotably linking these two brackets, the first bracket comprising a base plate portion having a bolt hole through which the bolt is inserted, a pair of arm plate portions standing up from upper and lower edges of at one end part, on the door side, of the base plate portion and supporting the hinge pin, and a pair of rib portions extending from the arm plate portion toward the other end part side of the base plate portion and standing up from the upper and lower edges of the base plate portion so as to oppose each other with the bolt hole interposed therebetween,
wherein opposite end parts, perpendicular to the extending direction of the rib portion, of the base plate portion are open, and the rib portion is formed so as to have a thickness that is larger than a thickness of the arm plate portion.

2. The door hinge for an automobile according to claim 1, wherein
the rib portion is formed so that an outside face thereof protrudes more than an outside face of the arm plate portion.

3. The door hinge for an automobile according to claim 1, wherein
a corner formed by an outside face of the rib portion and an outside face of the base plate portion is formed so as to be acute compared with a corner formed by the outside face of the arm plate portion and the outside face of the base plate portion.

4. The door hinge for an automobile according to claim 1, wherein
in order to restrict a fully open position of the door a fully-open stopper projection having a semi-circular cross section with a flat stopper face that receives the arm plate portion of the second bracket is formed so as to bulge on an inside face of the arm plate portion of the first bracket.

5. A method for manufacturing the first bracket of the door hinge for an automobile according to claim 1, comprising
a step of stamping out a starting steel plate to form a flat-plate bracket substrate having portions corresponding to the base plate portion, the arm plate portion, and the rib portion, a step of bending the arm plate portion and the rib portion at right angles relative to the base plate portion of the bracket substrate to thus obtain a partially-finished bracket product, and a step of thickening the rib portion of the partially-finished bracket product by an upsetting process, the steps being carried out in sequence.

6. The door hinge for an automobile according to claim 2, wherein
a corner formed by an outside face of the rib portion and an outside face of the base plate portion is formed so as to be acute compared with a corner formed by the outside face of the arm plate portion and the outside face of the base plate portion.

7. The door hinge for an automobile according to claim 2, wherein
in order to restrict a fully open position of the door a fully-open stopper projection having a semi-circular cross section with a flat stopper face that receives the arm plate portion of the second bracket is formed so as to bulge on an inside face of the arm plate portion of the first bracket.
